(19) United States
(12) Patent Application Publication
(10) Pub. No.: US 2026/0179822 A1
(43) Pub. Date: Jun. 25, 2026

(54) TLVR INDUCTOR WITH HEAT DISSIPATION STRUCTURE AND ELECTRONIC MODULE INCLUDING SAME

(71) Applicant: Murata Manufacturing Co., Ltd., Nagaokakyo-shi, Kyoto-fu (JP)

(72) Inventors: Takami MUTO, Westborough, MA (US); Hiroki MINAMI, Nagaokakyo-shi (JP); Hideaki KASHIURA, Nagaokakyo-shi (JP)

(21) Appl. No.: 19/425,894

(22) Filed: Dec. 18, 2025

Related U.S. Application Data
(60) Provisional application No. 63/736,115, filed on Dec. 19, 2024.

(51) Int. Cl. H01F 27/08; H01F 27/24; H01F 27/28

(52) U.S. Cl. CPC H01F 27/08; H01F 27/24; H01F 27/28

(57) ABSTRACT

An inductor includes a primary winding and a secondary winding that are electrically isolated from each other and provided between magnetic E-I cores in a stacking direction. The primary winding includes upside down U-shaped conductors arranged downward and the secondary winding includes U-shaped conductors arranged upwards. Extensions of the primary winding conductors each defining a heat-path portion are J-shaped so as to extend downwards and upwards. The J-shaped heat-path portion allows heat to dissipate from the magnetic core to the upper side and to the lower side.

### CROSS REFERENCE TO RELATED APPLICATIONS

This application claims the benefit of U.S. Patent Application No. 63/736,115 filed on Dec. 19, 2024. The entire contents of this application are hereby incorporated by reference.

### BACKGROUND OF THE INVENTION

### 1. Field of the Invention

The present invention relates to inductors with heat dissipation structures and electronic modules including the same.

### 2. Description of the Related Art

A TLVR inductor (Trans-Inductor Voltage Regulator inductor) is a specialized coupled inductor that enhances the performances of voltage regulators in high-current, low-voltage applications, like server processors, AI accelerators, and data center power supplies. A TLVR inductor functions essentially as a 1:1 transformer with a primary winding and a secondary winding. These windings are magnetically coupled through a shared ferrite (magnetic) core for efficient energy transfer during transients but electrically isolated (i.e., not directly or galvanically connected) to handle voltage differences without arcing or leakage current.

FIG. 10 shows a submodule 10 including an inductor 3a and configured to be mounted on a power supply module as described in Japanese Patent Application Publication No. 2024-545821 A. A substrate 6a of the submodule 10 is molded by resin 28a to cover electronic components on the principal surface of the substrate 6a. A heatsink 9a is included with the resin 28a. The inductor 3a is located underneath the substrate 6a, along with voltage input terminals 23a and 23b, ground terminals 22a and 22b, and other components (not shown).

The present inventors have realized that with inductors of the prior art, poor thermal coupling of the inductor prevents heat from being released. Thus, there is need to provide an inductor with improved heat dissipation.

### SUMMARY OF THE INVENTION

Example embodiments of the present invention provide inductors with improved heat dissipation structures and electronic modules including the same.

An inductor according to an example embodiment of the present invention includes a first magnetic core including a first main surface and a first inner surface, a second magnetic core including a second main surface and a second inner surface, a primary winding including a first conductor that includes a first conductor portion, and a secondary winding including a second conductor that is electrically isolated from the first conductor, the second conductor including a second conductor portion. The first magnetic core is provided on the second magnetic core in a stacking direction with the first inner surface and the second inner surface facing each other. The first conductor portion of the first conductor and the second conductor portion of the second conductor overlap with each other in the stacking direction and are sandwiched between the first magnetic core and the second magnetic core. The first conductor includes a first heat-path portion at a first side surface of the first magnetic core and a first side surface of the second magnetic core. The first heat-path portion extends from the second main surface to the first main surface in the stacking direction.

The first heat-path portion can include a J-shape. The first conductor can include a first terminal portion at a second side surface of the second magnetic core opposite to the first side surface, the first terminal portion can extend to the second main surface in the stacking direction. Each of the first heat-path portion and the first terminal portion can extend below the second main surface of the second magnetic core such that a gap space is provided between the second main surface and a mounting surface. The second conductor can include a terminal portion at each of the first side surface and the second side surface of the first magnetic core, and each terminal portion can extend to the first main surface in the stacking direction such that the second conductor includes a U-shape.

The primary winding can include a plurality of the first conductors, each including the first heat-path portion that includes the J-shape, and the secondary winding can include a plurality of the second conductors, each including the terminal portion at each of the first side surface and the second side surface of the second magnetic core, each terminal portion can extend to the first main surface in the stacking direction such that each of the plurality of second conductors includes a U-shape. The second inner surface of the second magnetic core can be flat or substantially flat. The first magnetic core can include a recess at the first inner surface. The first conductor portion of the first conductor and the second conductor portion of the second conductor can be provided in the recess. A thickness of the first conductor can be greater than a thickness of the second conductor.

A power supply module according to an example embodiment of the present invention includes a first substrate, the inductor according to one of the example embodiments of the present invention, and a second substrate mounted on the inductor. The first conductor of the inductor is connected to the first and the second substrates.

An inductor according to an example embodiment of the present invention includes a magnetic core including a top surface, a bottom surface opposite to the top surface, a first side surface, a second side surface opposite to the first side surface, and a first hole that extends between the first and the second side surfaces. The inductor further includes a first conductor including a first conductor portion that extends through the first hole, a first terminal that extends along the second side surface toward the bottom surface, a second terminal that extends along the first side surface toward the top surface, and a first heat-path portion that is connected to the second terminal and that extends between the top and the bottom surfaces. The inductor further includes a second conductor that is electrically isolated from the first conductor. The second conductor includes a second conductor portion that extends through the first hole such that the first and the second conductor portions face each other, a third terminal that extends along the first side surface toward the top surface, and a fourth terminal that extends along the second side surface toward the top surface.

The magnetic core can include a second hole that extends between the first and the second side surfaces. The inductor can further include a third conductor that includes a third conductor portion that extends through the second hole, a fifth terminal that extends along the first side surface toward the bottom surface, a sixth terminal that extends along the second side surface toward the top surface, a second heat-path portion that is connected to the sixth terminal and that extends between the top and the bottom surfaces. The inductor can further include a fourth conductor that is electrically isolated from the third conductor. The fourth conductor can include a fourth conductor portion that extends through the first hole such that the third and the fourth conductor portions face each other, a seventh terminal that extends along the first side surface toward the top surface, and an eighth terminal that extends along the second side surface toward the top surface.

The magnetic core can include third and fourth holes that extend between the first and the second side surfaces. The inductor can further include a fifth conductor that includes a fifth conductor portion that extends through the third hole, a ninth terminal that extends along the second side surface toward the bottom surface, a tenth terminal that extends along the first side surface toward the top surface, and a third heat-path portion that is connected to the tenth terminal and that extends between the top and the bottom surfaces. The inductor can further include a sixth conductor that is electrically isolated from the fifth conductor. The sixth conductor can include a sixth conductor portion that extends through the third hole such that the fifth and the sixth conductor portions face each other, an eleventh terminal that extends along the first side surface toward the top surface, and a twelfth terminal that extends along the second side surface toward the top surface.

The inductor can further include a seventh conductor that includes a seventh conductor portion that extends through the fourth hole, a thirteenth terminal that extends along the first side surface toward the bottom surface, a fourteenth terminal that extends along the second side surface toward the top surface, and a fourth heat-path portion that is connected to the fourteenth terminal and that extends between the top and the bottom surfaces. The inductor can further include an eighth conductor that is electrically isolated from the seventh conductor. The eighth conductor can include an eighth conductor portion that extends through the fourth hole such that the seventh and the eighth conductor portions face each other, a fifteenth terminal that extends along the first side surface toward the top surface, and a sixteenth terminal that extends along the second side surface toward the top surface.

A thickness of the first conductor can be greater than a thickness of the second conductor, a thickness of the third conductor can be greater than a thickness of the fourth conductor, a thickness of the fifth conductor can be greater than a thickness of the sixth conductor, and a thickness of the seventh conductor can be greater than a thickness of the eighth conductor. A gap space can be provided between the second main surface and a mounting surface. Each of the first conductor, the second conductor, the third conductor, the fourth conductor, the fifth conductor, the sixth conductor, the seventh conductor, and the eighth conductor can include a flat wire in which a thickness of the flat wire is less than a width of the flat wire. The magnetic core can be an E-I core.

An electronic module according to an example embodiment of the present invention includes a first substrate, a second substrate, and an inductor according to one of the example embodiments of the present invention that is located between the first substrate and the second substrate.

The electronic module can further include electronic components on the first substrate underneath the inductor. The electronic module can further include an electrical connector that is connected between the first substrate and the second substrate and that includes terminals that provide electrical connections between the first substrate and the second substrate. The electronic module can further include additional second substrates and additional inductors located between the additional second substrates and the first substrate.

The above and other features, elements, steps, configurations, characteristics, and advantages of the present invention will become more apparent from the following detailed description of example embodiments of the present invention with reference to the attached drawings.

### BRIEF DESCRIPTION OF THE DRAWINGS

FIG. 1 shows an inductor according to an example embodiment of the present invention.

FIG. 2 shows an exploded view of the inductor as shown in FIG. 1 according to an example embodiment of the present invention.

FIG. 3 shows the exploded view of the inductor together with the inductor assembled as shown in FIG. 1.

FIG. 4A shows a side-sectional view of the inductor as shown in FIG. 1.

FIG. 4B is an exploded view of the inductor showing heat dissipation paths.

FIG. 5A shows an electronic module according to an example embodiment of the present invention.

FIG. 5B shows the electronic module as shown in FIG. 5A with an electrical connector omitted.

FIG. 5C shows an exploded view of the electronic module as shown in FIG. 5A according to an example embodiment of the present invention.

FIG. 6 shows the electronic module as shown in FIG. 5A together with the exploded view of the electronic module as shown in FIG. 5C and the exploded view of the inductor as shown in FIG. 2.

FIG. 7 shows an electronic module according to another example embodiment of the present invention.

FIG. 8 shows an equivalent circuit diagram modeling a thermal resistance network of an inductor mounted between a top printed circuit board (PCB) and a bottom PCB.

FIG. 9 shows a cross-section of an inductor between a top PCB and bottom PCB.

FIG. 10 shows a front view of a submodule of the related art including an inductor and that is to be mounted on a power supply module.

### DETAILED DESCRIPTION OF EXAMPLE EMBODIMENTS

Hereinafter, example embodiments of the present disclosure will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The present invention relates to inductors with improved thermal coupling and electronic modules including the same that may be used, for example, in computing data servers, such as artificial intelligence (AI) servers.

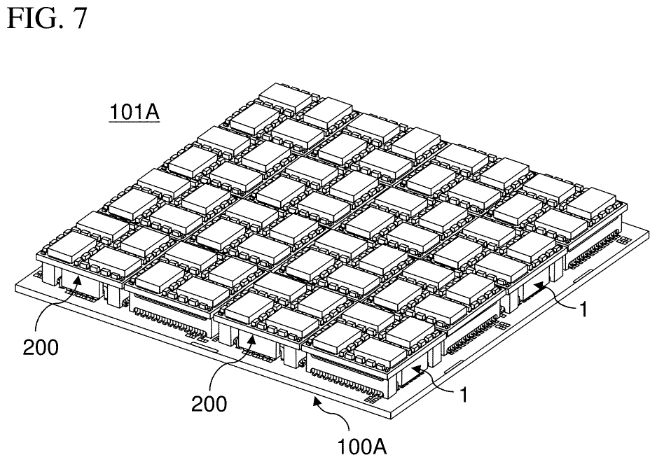

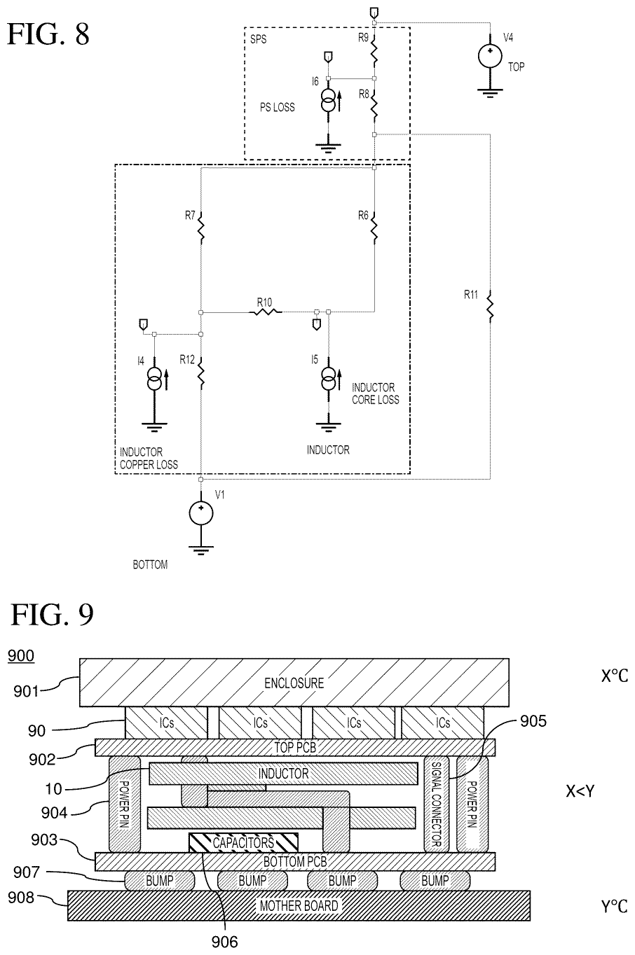

The following description explains the problem to be solved with respect to heat dissipation of the inductor with respect to FIGS. 8 and 9.

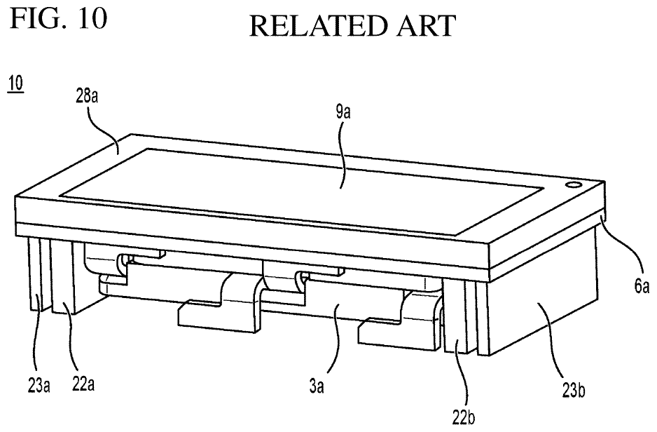

The presents inventors have realized that with inductors of the prior art, such as the inductor shown in FIG. 10, poor thermal coupling of the inductor prevents heat from being released.

FIG. 8 shows a thermal resistance network model (similar to an equivalent circuit diagram). The model in FIG. 8 shows how heat flows out of a power-supply inductor mounted between a top PCB and bottom PCB (such as the inductor shown in FIG. 9 or 10). FIG. 9 shows a cross-section of an inductor mounted between a top PCB and a bottom PCB.

FIG. 9 shows a cross-section of an inductor, such as the inductor shown in FIG. 10, mounted in a power supply module on a PCB, which accompanies the diagram shown in FIG. 8. As shown in FIG. 9, a power supply module 900, such as a module similar to the module shown in FIG. 10, includes an inductor mounted 10 mounted and connected between a top printed circuit board (PCB) 902 and a bottom PCB 903. The bottom PCB 903 is connected to a motherboard 908 via bumps 907. Power Pin terminals 904 and a signal connector 905 are also connected between the top PCB 902 and the bottom PCB 903. Capacitors 906 are located underneath the inductor 10. Integrated circuits (ICs) 90 are mounted on the top PCB 902. An enclosure 901 (chassis or case) functions as a heatsink for the ICs 90.

Referring to FIGS. 8 and 9, the heat from the inductor is mainly dissipated to the top and bottom via the inductor windings. There may be resin between the magnetic core of the inductor and the board (e.g., a PCB), which also dissipates heat. In the diagram shown in FIG. 8, the main heat dissipation route is through R6, R7, R8, R9, R10, etc. The route through R12 is not being used effectively.

More specifically, as shown in FIG. 8, heat sources inside the inductor include inductor core loss (heat generated in the magnetic core itself due to hysteresis/eddy currents) and inductor copper loss. The diagram in FIG. 8 includes a ladder/network of thermal resistances (R6, R7, R8, R9, R10, R11, R12, etc.) like an electrical circuit diagram, but for heat flow instead of current. V1 and V4 denote voltage sources at the bottom and the top, respectively, and 14, 15, 16 denote current sources in the analog thermal model.

In FIG. 8, a switching power supply (SPS) is an example of a power module, which may be a DC-DC or an AC-DC converter that uses high-frequency switching. A complete assembly of a switching power supply (SPS) may include ICs (e.g,, MOSFETs/GaN transistors), a controller IC, the inductor, capacitors, PCBs, heatsinks, enclosures, etc. as shown, for example, in FIG. 9. In FIG. 8, “PS LOSS” denotes the power stage loss, also known as “power supply loss” excluding the inductor. This is the heat generated primarily by the switching transistors (e.g, MOSFETs or GaN FETs) and to a lesser extent by rectifiers, drivers, etc. of the switching power supply (SPS). In the thermal resistance diagram of FIG. 8, “PS loss” is shown as a separate heat source injected into the SPS block (the upper part of the model), distinct from the inductor's own losses. Inductor losses are split into: “copper loss” (i.e., FR losses in the windings) which is shown at the bottom left of the inductor block, and “core loss” (i.e., hysteresis+eddy current losses in the magnetic core) which is shown at the bottom right of the inductor block. PS loss is the heat coming from the active switching devices that are physically located above the inductor on the top PCB. In some layouts in server or power supply unit (PSU) designs, such as that shown in FIG. 9, the MOSFETs, GaN FETs, or integrated circuits (ICs) are mounted on the top side of the PCB or on a daughterboard directly above the inductor, so the heat of such MOSFETs or ICs flows into the same thermal network but through different paths (usually better coupled to top-side heatsinks).

While the MOSFET heat (PS loss) can escape relatively well to the top, some heat in the inductor's magnetic core is trapped. Since the bottom of the core may be isolated by resin, and due to a high thermal resistance value of R12, the cold chassis (enclosure) or heatsink cannot be utilized effectively.

As shown in FIG. 9, temperature labels show X° C. corresponding to the enclosure (chassis) that is usually metal, and may be passively or actively cooled, and Y° C. corresponding to the motherboard (mainboard) or bottom side. The chassis (enclosure) is significantly cooler than the board/inductor area (X<Y). With the temperature difference available, the design of previous inductors, such as the inductor shown in FIG. 10, is not utilizing the available temperature difference because the heat in inductor's magnetic core is trapped and cannot reach the cool chassis effectively.

As described above, referring to FIGS. 8 and 9, heat from the inductor is mainly dissipated to the top and bottom via the inductor windings. There is resin between the magnetic core and the board, which also dissipates heat (via secondary path R11). In FIG. 8, the main heat dissipation route is to the top surface via R6, R7, R8, R9, R10, etc. The route through R12 (and the secondary path R11) is not being used effectively.

Features of example embodiments of the present invention will now be explained.

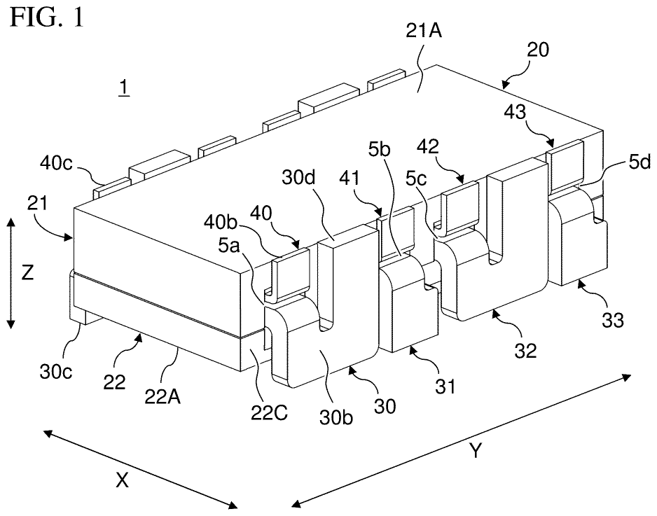

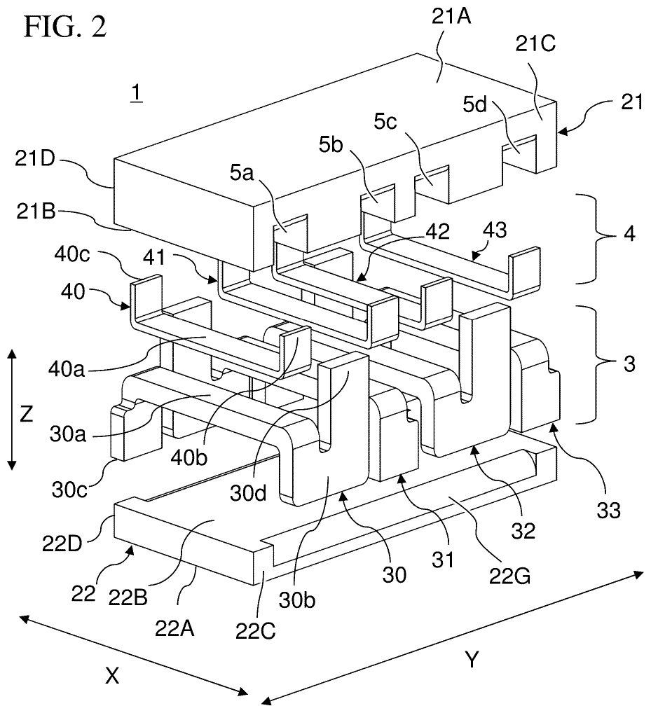

FIG. 1 shows an inductor 1 according to an example embodiment of the present invention. FIG. 2 shows an exploded view of the inductor 1 as shown in FIG. 1. As shown in FIGS. 1 and 2, the inductor 1 includes a magnetic core 20, a primary winding 3, and a secondary winding 4. As shown in FIGS. 1 and 2, the inductor 1 can be a TLVR inductor, and the magnetic core 20 can be an E-I core. As shown in FIGS. 1 and 2, a stacking direction Z, a width direction X, and a length direction Y are labeled.

As shown in FIGS. 1 and 2, the magnetic core 20 includes a top surface (first main surface) 21A, a bottom surface (second main surface) 22A opposite to the top surface 21A, a first side surface 21C (22C), a second side surface 21D (22D) opposite to the first side surface 21C (22C) in the X-direction, and a first hole 5a that extends between the first and the second side surfaces 21C, 21D in the X-direction. In this example embodiment, the magnetic core 20 includes a first magnetic core 21 including the first main surface 21A and a first inner surface 21B, and a second magnetic core 22 including a second main surface 22A and a second inner surface 22B. The first magnetic core 21 is provided on the first magnetic core 22 in the stacking direction Z with the first inner surface 21B and the second inner surface 22B facing each other in the stacking direction Z. The stacking direction Z is orthogonal or substantially orthogonal to the X-direction and the Y-direction, within manufacturing and/or measurement tolerances. Although the magnetic core 20 in FIGS. 1 and 2 includes an E-I core, other possible arrangements are also possible. For example, the magnetic core can be an E-E core or can be included in more than two sections. The primary winding 3 includes a first conductor 30. As shown in FIG. 2, the first conductor 30 includes a first conductor portion 30a that extends in a first direction which corresponds to a direction parallel or substantially parallel to the X-direction, within manufacturing and/or measurement tolerances. In this example embodiment, the X-direction corresponds to a width direction of the inductor 1. It is understood that the first direction does not necessarily have to be parallel to the X-direction, and may be in any direction in the X-Y plane. The first conductor 30 includes a first heat-path portion 30b at a first side surface 21C of the first magnetic core and a first side surface 22C of the second magnetic core 22. As shown in FIGS. 1 and 2, the first heat-path portion 30b extends from the second main surface 22A to the first main surface 21 in the stacking direction Z. In this example embodiment, the first heat-path portion 30b includes a J-shape as shown in FIGS. 1 and 2. The first conductor 30 also includes a first terminal portion (first terminal) 30c at a second side surface 22D of the second magnetic core 22, and the second side surface 22D is opposite to the first side surface 22C. The first terminal portion 30c extends to the second main surface 22A in the stacking direction Z.

The secondary winding 4 includes a second conductor 40 that is electrically isolated from the first conductor 30. Herein, the term “electrically isolated” means that there is no direct electrical connection (i.e., not galvanically connected). In a TLVR inductor, the windings are physically separate and insulated, acting like a transformer, often with a 1:1 turns ratio. The primary and secondary windings of a TLVR inductor are electrically isolated from each other, meaning there is no direct electrical (galvanic) connection between them. However, the primary winding and the secondary winding are coupled magnetically, similar to a transformer. As shown in FIG. 2, the second conductor 40 includes a second conductor portion 40a that extends in the X-direction. As shown in FIGS. 1 and 2, the first conductor portion 30a of the first conductor 30 and the second conductor portion 40a of the second conductor 40 overlap with each other in the stacking direction Z and are sandwiched between the first magnetic core 21 and the second magnetic core 22.

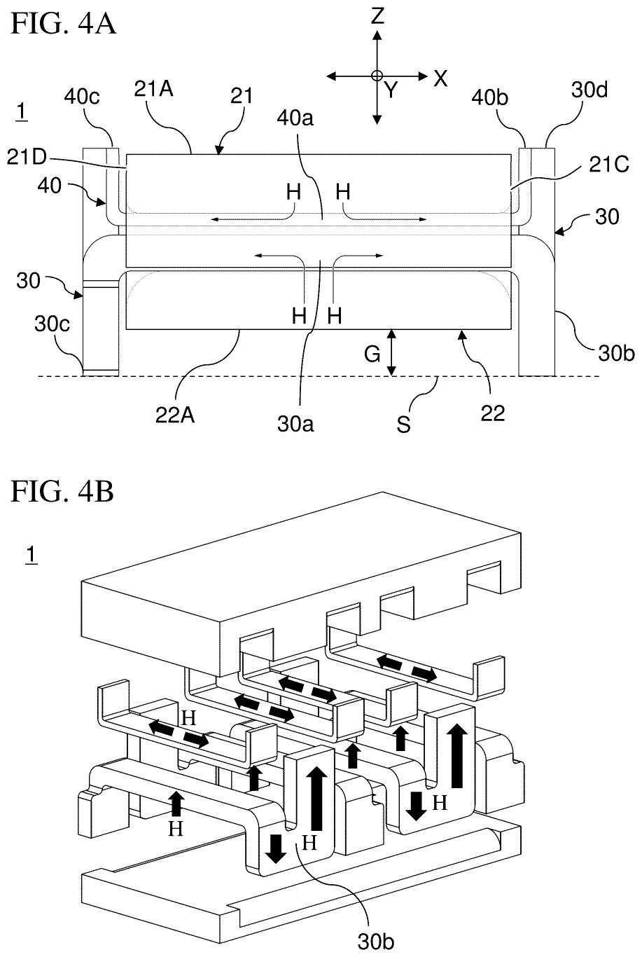

As shown in FIG. 2, the second inner surface 22B of the second magnetic core 22 is flat or substantially flat. A rounded corner 22G is provided at each side surface 22C, 22D of the second magnetic core (lower magnetic core) 22. The rounded corner 22G accommodates the fitting of the conductors 30, 31, 32, 33 of the primary winding 3. The first magnetic core 21 includes a plurality of recesses at the first inner surface 21B. Each of the plurality of recesses defines a hole 5a, 5b, 5c, 5d. The first conductor portion 30a of the first conductor 30 and the second conductor portion 40a of the second conductor 40 are provided in a corresponding recess. In the words, a first hole 5a extends between the first and the second side surfaces (21C, 21D), and each of the first conductor portion 30 and the second conductor portion 40a extend through the first hole 5a. As shown in FIGS. 2 and 4A, a thickness of the first conductor 30 can be greater than a thickness of the second conductor 40. But other arrangements are also possible. For example, a thickness of the first conductor 30 can be smaller than a thickness of the second conductor 40, or a thickness of the first conductor 30 can be the same or substantially the same as a thickness of the second conductor 40, within manufacturing and/or measurement tolerances.

As shown in FIGS. 1 and 2, the first conductor 30 includes the first conductor portion 30a that extends through the first hole 5a. The first conductor 30 includes a first terminal 30c that is connected to the first conductor portion 30a and extends along the second side surface 22D toward the bottom surface (second main surface) 22A. The first conductor 30 also includes a second terminal 30d that extends along the first side surface 22C toward the top surface 21A. The first conductor 30 also includes the first heat-path portion 30b that is connected to the second terminal 30d and that extends between the top and the bottom surfaces 21A, 22A. Accordingly, the first conductor 30 defines an upside down U-shaped conductor portion as seen in the Y-direction and defines a J-shaped conductor portion (30b) as seen in the X-direction.

As shown in FIGS. 1 and 2, the second conductor 40 includes a second conductor portion 40a that extends through the first hole 5a such that the first and the second conductor portions 30a, 40a face each other. The second conductor 40 also includes a third terminal 40b that extends along the first side surface 21C toward the top surface 21A, and a fourth terminal 40c that extends along the second side surface 21D toward the top surface 21A. Accordingly, the second conductor 40 defines a U-shaped conductor as seen in the Y-direction.

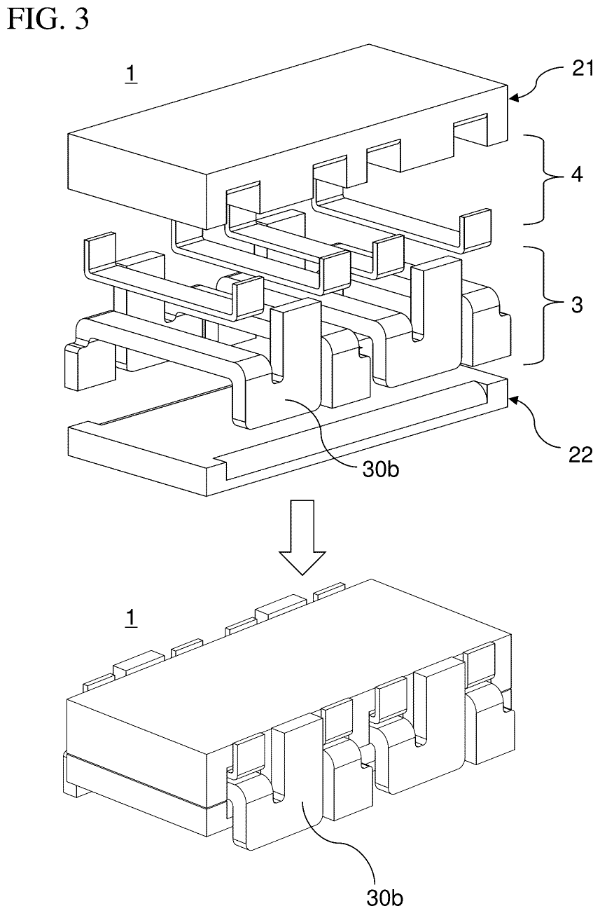

FIG. 3 shows the exploded view of the inductor as shown in FIG. 2 together with the inductor assembled as shown in FIG. 1. In FIG. 3, reference characters and labeling are omitted to visualize how the structural elements of the inductor are arranged. As shown in FIG. 3, the J-shaped heat path portion 30b allows heat to dissipate the heat from the inductor upwards and downwards. This conductor portion 30b provides an additional heat dissipation structure that is used as a thermal path to improve thermal coupling. This conductor portion 30b can be configured to connect to a power supply circuit, i.e., current is flowing through the conductor portion 30b when the inductor 1 is in use in a power supply module.

As shown in FIGS. 1-3, the primary winding 3 may include a plurality of conductors 30, 31, 32, and 33, and the secondary winding 4 may include a plurality of conductors 40, 41, 42, and 43. That is, a first conductor 30, a second conductor 40, a third conductor 31, a fourth conductor 41, a fifth conductor 32, a sixth conductor 42, a seventh conductor 33, and an eight conductor 43 are provided as shown in FIGS. 1-3. Each of the secondary winding conductors 40, 41, 42, and 43 have the same structure, and each of the primary winding conductors 30, 31, 32, and 33 have the same structure. However, the primary winding conductors 30, 31, 32, and 33 are arranged in alternating orientations as shown in FIGS. 1-3. As shown in FIGS. 1-3, the third conductor 31 is rotated 180 degrees around the Z-axis with respect to the first conductor 30 such that opposite ends are adjacent to each other. The same arrangement is applied to the adjacent conductors 31, 32, and the adjacent conductors 32 and 33. This arrangement increases wiring density and provides a compact structure while also providing improved thermal coupling of the TLVR inductor when the number of windings is increased. It will be appreciated that the number conductors (windings) in the primary winding and the secondary winding are not limited to what is shown in the drawings of the present application. For example, more than four, or less than four, of each the conductors of the primary winding 3 and the conductors of the secondary winding 4 can be provided. The number of conductors is not limited as long as there is at least one conductor (30) for the primary winding 3 and at least conductor (40) of the secondary winding 4.

The first conductor 30 and the second conductor 40 are electrically isolated from each other but are magnetically coupled to each other. Isolation material can be provided between the first conductor 30 and the second conductor 40. The two conductors 31, 41 are electrically isolated from each other, and there can be an isolation material therebetween. The same configuration applies to the two conductors 32, 42 facing each other in the stacking direction Z, and the two conductors 33, 43 facing each other in the stacking direction.

As shown in FIGS. 1-3, each of the first conductor 30, the second conductor 40, the third conductor 31, the fourth conductor 41, the fifth conductor 32, the sixth conductor 42, the seventh conductor 33, and the eighth conductor 43 includes a flat wire in which a thickness of the flat wire is less than a width of the flat wire.

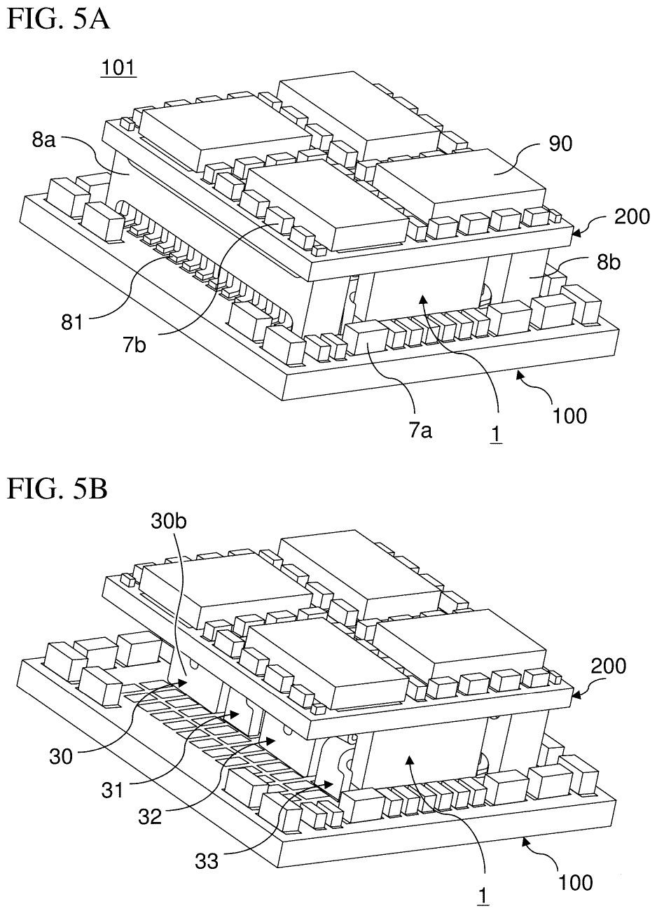

FIG. 4A shows a side-sectional view of the inductor 1 as shown in FIG. 1. As shown in FIG. 4A, heat (annotated as arrows H) from the upper magnetic core 21 is dissipated by the upper core winding (secondary winding) 40, and heat (H) from the lower magnetic core 22 is dissipated by the primary winding including the first conductor 30. As shown in FIG. 4, each of the first heat-path portion 30b and the first terminal portion 30c extends below the second main surface 22A of the second magnetic core 22 such that a gap space G is provided between the second main surface 22A and a mounting surface S. The mounting surface S is a surface on which the inductor 1 is to be mounted, such as the surface of a printed circuit board (PCB) or substrate. The gap space G provides a space to accommodate electrical components underneath the inductor 1, as will be further described in FIG. 5C. It is also possible that no gap space G is provide below the lower magnetic core 22.

As shown in FIGS. 2 and 4A, the second conductor 40 includes a terminal portion 40b, 40c at each of the first side surface 21C and the second side surface 21D of the first magnetic core 21 and extends to the first main surface 21A in the stacking direction Z. As shown in FIG. 4A, the second conductor 40 includes a U-shape.

As described above, the primary winding 3 includes a plurality of conductors 30, 31, 32 33, each including a downwards U-shape (when viewed in the side-sectional view as shown in FIG. 4A) and including the first heat-path portion 30b that includes the J-shape. The secondary winding 4 includes a plurality of the second conductors 41, 42, 43, 44, each including the terminal portion 40b, 40c at each of the first side surface 21C and the second side surface 21D of the second magnetic core 21 that extends to the first main surface 21 in the stacking direction Z such that each of the plurality of second conductors 41, 42, 43, 44 includes a U-shape.

Referring to FIGS. 1, 2, and 4A, all or part of an edge of the terminals 40b, 40c of each of the conductors 40, 41, 42, 43 of the secondary winding 4 be configured to be connected to a circuit of a top PCB (or upper substrate) (mounted on top of the inductor 1) to be used as a current path. And all the terminals 40b, 40c of each of the conductors 40, 41, 42, 43 of the secondary winding 4 can be connected to the top PCB (or upper substrate) via solder to be used as thermal path. Referring to FIGS. 1, 2, and 4A, the lower terminal 30c of each primary winding conductor 30, 31, 32, and 33 is soldered to a lower substrate, and the upper terminal 30d part of each primary winding conductor 30, 31, 32, and 33 can be soldered to the upper substrate. Further, the primary winding 3 may generally be fixed to the lower magnetic core 22 with resin, but between the upper core 21 and the primary winding 3, there may be an insulation material and the TL winding (secondary winding 4).

FIG. 4B shows the exploded view of the inductor 1 with annotated heat dissipation paths H. With the configuration described above in the example embodiments shown in FIGS. 1 to 4B, example embodiments of the present invention provide a coupled inductor (for example, a TLVR inductor) that includes a plurality of U-shaped conductors arranged upward and downward between E-I cores. Extension portions defining the heat-path portions 30b of each of the bottom U-shaped conductors are J-shaped and extend downwards to the mounting surface of a lower substrate and then upwards to connect to an upper substrate. The J-type wire (heat-path portion 30b) allows heat to dissipate from the magnetic core to the upper side and to the lower side. Accordingly, thermal coupling of the inductor is improved.

FIG. 5A shows an electronic module 101 according to an example embodiment of the present invention. The electronic module 101 includes a first substrate 100, a second substrate 200, and an inductor 1 located between the first substrate 100 and the second substrate 200. The electronic module 101 may be a power supply module. A plurality of electronic components 7a are provided on the first substrate 100. A plurality of electronic components 7a and a plurality of integrated circuits (ICs) 90 are provided on the second substrate 100. In FIG. 5A, four ICs 90 are shown, but any number of ICs 90 can be used. Located on each side of inductor 1 are electrical connectors 8a and 8b including terminals 81 that provide electrical connections between the first substrate 100 and the second substrate 200.

FIG. 5B shows the electronic module as shown in FIG. 5A with the electrical connector 8A omitted. The first conductor 30, as well as each of the other conductors 31, 32, 33 of the primary winding 3, is connected to the first and the second substrates 100, 200. As shown in FIG. 5B, a point between the first conductor 30 and the first substrate 100 is connected with resin or solder and is used as a thermal path, while also physically fixing the inductor component 1 in place.

FIG. 5C shows an exploded view of the electronic module 101 as shown in FIG. 5A according to an example embodiment of the present invention. As shown in FIG. 5C, the electronic module 101 includes electronic components 7c on the first substrate 100 underneath the inductor 1. An electrical connector 8a (and 8b) is connected between the first substrate 100 and the second substrate 200 and includes terminals 81 that provide electrical connections between the first substrate 100 and the second substrate 200. The first substrate 100 includes land pads 203 that connect to the terminals 81, and land pads 201 and 202 that connect to the conductors 31 and 33 of the primary winding 3 of the inductor 1.

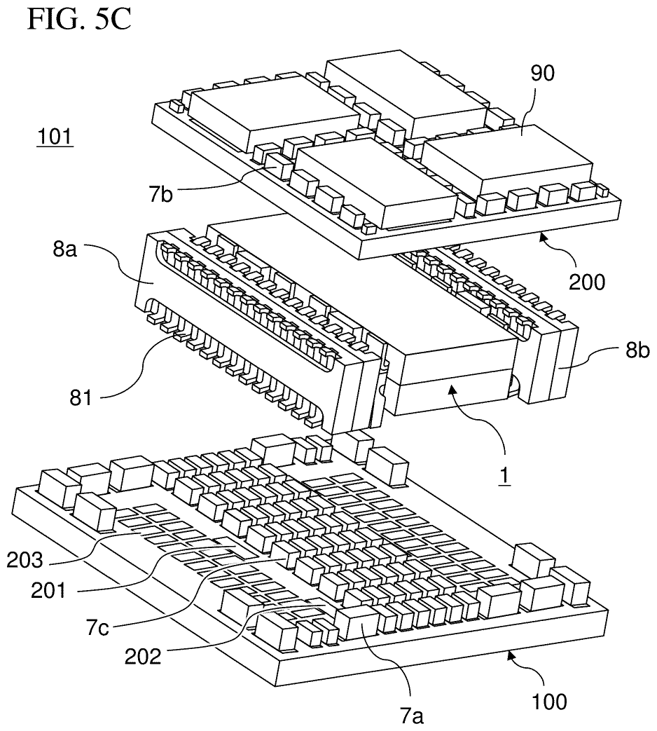

FIG. 6 shows the electronic module 101 as shown in FIG. 5A together with the exploded view of the electronic module as shown in FIG. 5C and the exploded view of the inductor 1 as shown in FIG. 2.

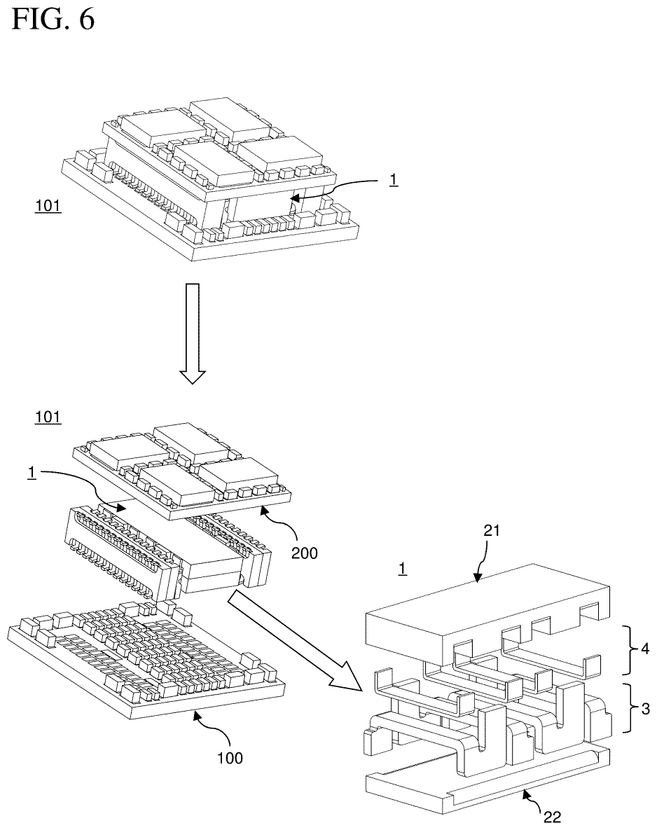

FIG. 7 shows an electronic module 101A according to another example embodiment of the present invention. In this example, multiple (additional) second substrates 200 are provided, and multiple (additional) inductors 1 are located between the additional second substrates 200 and the first substrate 100A. In FIG. 7, the first substrate 100A is larger than the substrate 100 in FIGS. 5A-5C. The larger substrate 100A can accommodate multiple submodules to provide a multi-module power supply. In FIG. 7, sixteen (16) submodules, each including an inductor 1 and a second substrate 200, are provided in a 4×4 array.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inductor comprising:
a first magnetic core including a first main surface and a first inner surface;
a second magnetic core including a second main surface and a second inner surface;
a primary winding including a first conductor, the first conductor including a first conductor portion; and
a secondary winding including a second conductor that is electrically isolated from the first conductor, the second conductor including a second conductor portion; wherein
the first magnetic core is provided on the second magnetic core in a stacking direction with the first inner surface and the second inner surface facing each other;
the first conductor portion of the first conductor and the second conductor portion of the second conductor overlap with each other in the stacking direction and are sandwiched between the first magnetic core and the second magnetic core; and
the first conductor includes a first heat-path portion at a first side surface of the first magnetic core and a first side surface of the second magnetic core, the first heat-path portion extends from the second main surface to the first main surface in the stacking direction.

2. The inductor according to claim 1, wherein the first heat-path portion includes a J-shape.

3. The inductor according to claim 1, wherein
the first conductor includes a first terminal portion at a second side surface of the second magnetic core opposite to the first side surface, the first terminal portion extends to the second main surface in the stacking direction.

4. The inductor according to claim 3, wherein each of the first heat-path portion and the first terminal portion extends below the second main surface of the second magnetic core such that a gap space is provided between the second main surface and a mounting surface.

5. The inductor according to claim 1, wherein
the second conductor includes a terminal portion at each of the first side surface and the second side surface of the first magnetic core, each terminal portion extends to the first main surface in the stacking direction such that the second conductor includes a U-shape.

6. The inductor according to claim 1, wherein
the primary winding includes a plurality of the first conductors, each including the first heat-path portion that includes the J-shape; and
the secondary winding includes a plurality of the second conductors, each including the terminal portion at each of the first side surface and the second side surface of the second magnetic core, each terminal portion extends to the first main surface in the stacking direction such that each of the plurality of second conductors includes a U-shape.

7. The inductor according to claim 1, wherein
the second inner surface of the second magnetic core is flat or substantially flat;
the first magnetic core includes a recess at the first inner surface; and
the first conductor portion of the first conductor and the second conductor portion of the second conductor are provided in the recess.

8. The inductor according to claim 1, wherein a thickness of the first conductor is greater than a thickness of the second conductor.

9. A power supply module comprising:
a first substrate;
the inductor according to claim 1 mounted on the first substrate; and
a second substrate mounted on the inductor; wherein
the first conductor is connected to the first and the second substrates.

10. An inductor comprising:
a magnetic core including:
a top surface;
a bottom surface opposite to the top surface;
a first side surface;
a second side surface opposite to the first side surface; and
a first hole that extends between the first and the second side surfaces;
a first conductor including:
a first conductor portion that extends through the first hole;
a first terminal that extends along the second side surface toward the bottom surface;
a second terminal that extends along the first side surface toward the top surface; and
a first heat-path portion that is connected to the second terminal and that extends between the top and the bottom surfaces; and
a second conductor that is electrically isolated from the first conductor and that includes:
a second conductor portion that extends through the first hole such that the first and the second conductor portions face each other;
a third terminal that extends along the first side surface toward the top surface; and
a fourth terminal that extends along the second side surface toward the top surface.

11. The inductor according to claim 10, wherein
the magnetic core includes a second hole that extends between the first and the second side surfaces;
the inductor further includes:
a third conductor including:
a third conductor portion that extends through the second hole;
a fifth terminal that extends along the first side surface toward the bottom surface;
a sixth terminal that extends along the second side surface toward the top surface; and
a second heat-path portion that is connected to the sixth terminal and that extends between the top and the bottom surfaces; and
a fourth conductor that is electrically isolated from the third conductor and that includes:
a fourth conductor portion that extends through the first hole such that the third and the fourth conductor portions face each other;
a seventh terminal that extends along the first side surface toward the top surface; and
an eighth terminal that extends along the second side surface toward the top surface.

12. The inductor according to claim 11, wherein
the magnetic core includes third and fourth holes that extend between the first and the second side surfaces;
the inductor further includes:
a fifth conductor including:
a fifth conductor portion that extends through the third hole;
a ninth terminal that extends along the second side surface toward the bottom surface;
a tenth terminal that extends along the first side surface toward the top surface; and
a third heat-path portion that is connected to the tenth terminal and that extends between the top and the bottom surfaces;
a sixth conductor that is electrically isolated from the fifth conductor and that includes:
a sixth conductor portion that extends through the third hole such that the fifth and the sixth conductor portions face each other;
an eleventh terminal that extends along the first side surface toward the top surface; and
a twelfth terminal that extends along the second side surface toward the top surface;
a seventh conductor including:
a seventh conductor portion that extends through the fourth hole;
a thirteenth terminal that extends along the first side surface toward the bottom surface;
a fourteenth terminal that extends along the second side surface toward the top surface; and
a fourth heat-path portion that is connected to the fourteenth terminal and that extends between the top and the bottom surfaces; and
an eighth conductor that is electrically isolated from the seventh conductor and that includes:
an eighth conductor portion that extends through the fourth hole such that the seventh and the eighth conductor portions face each other;
a fifteenth terminal that extends along the first side surface toward the top surface; and
a sixteenth terminal that extends along the second side surface toward the top surface.

13. The inductor according to claim 12, wherein:
a thickness of the first conductor is greater than a thickness of the second conductor;
a thickness of the third conductor is greater than a thickness of the fourth conductor;
a thickness of the fifth conductor is greater than a thickness of the sixth conductor; and
a thickness of the seventh conductor is greater than a thickness of the eighth conductor.

14. The inductor according to claim 10, wherein a gap space is provided between the second main surface and a mounting surface.

15. The inductor according to claim 10, wherein each of the first conductor, the second conductor, the third conductor, the fourth conductor, the fifth conductor, the sixth conductor, the seventh conductor, and the eighth conductor includes a flat wire in which a thickness of the flat wire is less than a width of the flat wire.

16. The inductor according to claim 10, wherein the magnetic core is an E-I core.

17. An electronic module comprising:
a first substrate;
a second substrate; and
the inductor according to claim 10 located between the first substrate and the second substrate.

18. The electronic module according to claim 17, further comprising electronic components on the first substrate underneath the inductor.

19. The electronic module according to claim 17, further comprising an electrical connector that is connected between the first substrate and the second substrate and that includes terminals that provide electrical connections between the first substrate and the second substrate.

20. The electronic module according to claim 17, further comprising:
additional second substrates; and
additional inductors located between the additional second substrates and the first substrate.
